(19) United States
(12) Patent Application Publication
(10) Pub. No.: US 2004/0063896 A1
(43) Pub. Date: Apr. 1, 2004

(54) Resin compositions for press-cured mica tapes for high voltage insulation

(76) Inventors: Mark Markovitz, Schenectady, NY (US); William Gene Newman, Scotia, NY (US); Alan Michael Iversen, Clifton Park, NY (US); Mabel S. Yung, Clifton Park, NY (US)

Correspondence Address: NIXON & VANDERHYE P.C., 8th Floor, 1100 North Glebe Rd., Arlington, VA, 22201-4714, US

(21) Appl. No.: 10/259,389

(22) Filed: Sep. 30, 2002

(51) Int. Cl. C08G 59/68

(52) U.S. Cl. 528/92

(57) ABSTRACT

Resin composition comprising an epoxy resin having an epoxide functionality of at least 2.5, a cycloaliphatic epoxy resin, a phenol-formaldehyde novolac and aluminum acetylacetonate. The resin is heat stable and is suitable for fabrication of resin-rich mica tapes having low reactivity at ambient temperatures for good shelf life stability combined with high reactivity above 140° C. for application in press-cured tapes. The dissipation factors at room temperature to at least 200° C. are less than 3.0%.

The present invention relates generally to resin compositions. More specifically, the present invention relates to resin compositions that enable the manufacture of resin-rich press-cure mica tapes that combine high reactivity with good shelf life stability at room and refrigerated temperatures.

### BACKGROUND OF THE INVENTION

A widely used method to insulate high voltage stator bars of generators is to manufacture prepregs of mica paper and a woven fabric backer, such as fiberglass, or a combination of mica paper with two backers. One of the two backers may be a woven fabric such as fiberglass and the other backer may be another woven fabric, a non-woven fabric such as polyester mat or a film such as MYLAR™ polyester or KAPTON™ polyimide. A resin binder is used to permeate through the mica paper and to bond the backer(s) to the mica paper. Resin binder is also on the backers.

An effective binder to hold together the mica paper and backer(s) is a solid or semi-solid resin at room temperature which must be flexible to make the prepreg pliable. The binder must have a high enough molecular weight to act as an adhesive for bonding the prepreg components together and it must also be tack-free or only slightly tacky to prevent blocking of the prepreg.

The mica paper having one or two backers that are bonded together as a prepreg is slit into tapes for wrapping around the conductor such as a high voltage generator stator bar. Multiple layers of tape are wrapped around the conductor. After the required number of tape layers are applied, usually by one half lap taping, the bar is taped with release film tapes, such a TEDLAR™ poly(vinyl fluoride), and placed in a press to apply heat and pressure. The TEDLAR™ prevents bonding of the resin to the press plates. The taped bar is heated under pressure to allow the multiple mica tape layers to fuse together and for the resin to solidify. After pressing, usually 1 to 3 hours at 150 to 175° C., the bar is post-cured in an oven to complete the cure of the resin.

The requirements of the resin used in the mica tape for press-cure processing include the following. The resin must be stable enough at room temperature for the mica tape to have long shelf stability, for example, at least three months at room temperature and more than six months when refrigerated. The resin must be sufficiently reactive during the press-cure to minimize the time needed in the press. The less time in the press, preferably no more than 2 hours, the more efficient is the manufacturing process. The resin must be sufficiently reactive to cause sufficient cure during the short press-cure time so that there is dimensional stability of the insulation during the post-cure. If sufficient cure does not occur during the press-cure, the insulation will “puff” or delaminate which is strongly detrimental to insulation performance. Insulation that has delaminated must be removed and replaced.

The dissipation factor, also called tan delta, of the insulation should be as low as possible to minimize heating and prolong its life expectancy. Dissipation factor is a nondimensional term which is the ratio of energy dissipated as heat in watts to the quantity of energy stored. Dissipation factor increases with temperature. Some guidelines call for a maximum of 10% at operating temperatures and stresses. Since dissipation factor increases with temperature, operating under conditions where the dissipation factor is high causes the insulation to further increase in temperature, which in turn further increases the dissipation factor and can lead to a thermal runaway condition that causes insulation failure.

Heretofore, epoxy resins have not met all the optimum properties needed in a press-cured mica tape. While there are many high reactivity epoxy resin compositions that use amines and imidazoles as curing agents, these materials have a shelf life stability of no more than a couple of days and poor electrical properties at elevated temperatures. Epoxy resin compositions that use acid anhydrides or polycarboxylic acids as curing agents generally have excellent high temperature electrical properties but these materials have inadequate shelf life stability and generally cure too slowly for press-cure tapes.

The current epoxy compositions used to manufacture press-cure mica tapes use catalysts that are based on boron trifluoride-amine or boron trichlorideamine complexes. While these materials meet the requirements of high reactivity under press-cure conditions combined with acceptable shelf life stability at room temperature, the electrical properties at elevated temperatures are just borderline acceptable.

In the past, press-cured mica tapes have used epoxy resin compositions that contain a boron trifluoride-amine or a boron trichloride-amine catalyst. These catalysts form ionic compounds during cure that cause the high dissipation values at elevated temperatures.

U.S. Pat. No. 3,563,850 (Stackhouse) and U.S. Pat. No. 5,618,891 (Markovitz) disclose resin compositions for mica tapes that have the low dissipation factor values desirable in a press-cure tape. However, the compositions in the '850 and '891 patents are too low in reactivity to be useful in press-cure tapes.

U.S. Pat. No. 3,812,214 (Markovitz) discloses epoxy resin compositions that use aluminum, titanium, zinc, zirconium and many other metal acetylacetonates. However, compositions desirable as tape binders in presscured tapes are not disclosed nor is the requirement of a blend of two different types of epoxy resins to meet the objectives of this invention.

### BRIEF DESCRIPTION OF THE INVENTION

It has now been found, according to the present invention, that it is possible to provide a resin composition that enables the manufacture of resin-rich press-cure mica tapes that combine high reactivity at from, for example, about 140 to 175° C., with good shelf life stability at room and refrigerated temperatures.

The resins of the invention have the advantage that the cure advances sufficiently during short presscure times to allow the post-cure of the insulation to proceed without delamination of the insulation. Moreover, the resin compositions contain no ionic species such as fluorides or chlorides that are detrimental to the electrical properties of insulating materials, and the cured insulation has low dissipation factors at elevated temperatures and high thermal stability properties to achieve good insulation performance at elevated temperatures.

### BRIEF DESCRIPTION OF THE DRAWINGS

FIG. 1 shows a stator bar for a generator and illustrates the general concepts of the invention;

FIG. 2 is mica paper tape prepeg composed of a mica paper backed by a single woven backing;

FIG. 3 is mica paper tape prepeg composed of a mica paper backed by a pair of backings.

### DETAILED DESCRIPTION OF THE INVENTION

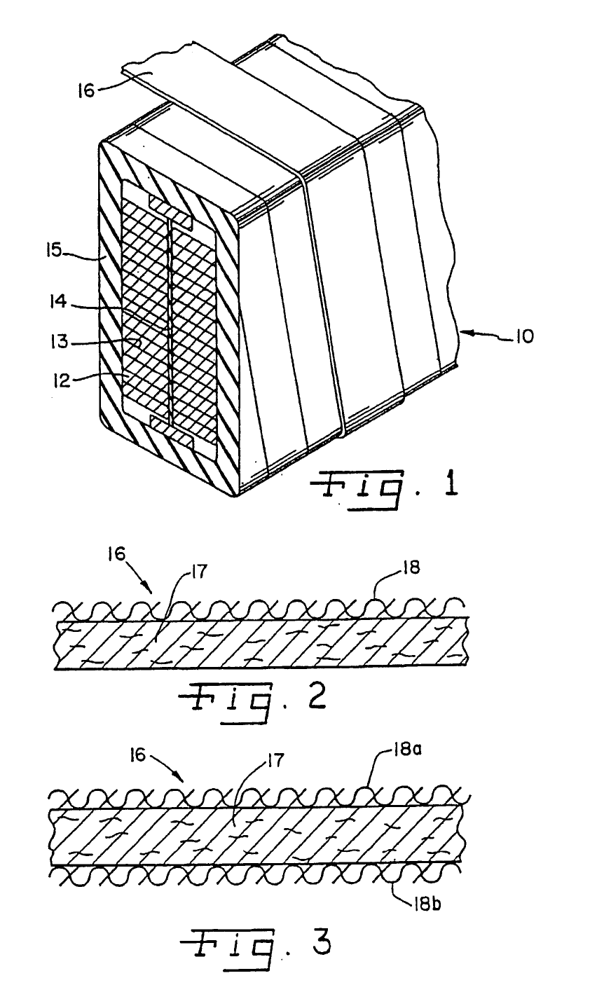

Referring to the drawings, FIG. 1 shows a stator bar 10 for a generator (not shown). The stator bar 10 is composed of a number of conducting copper strands 12 that are insulated from each other by strand insulation 13, as is conventional in the art. In addition, the conductor strands 12 are arranged to form two arrays that are separated by a strand separator 14. Surrounding both arrays is a groundwall insulation 15 formed by multiple wrappings of a mica paper tape 16 in accordance with the present invention. While not shown in FIG. 1, the stator bar 10 may also contain a layer of conductive tape for internal grading at the interface of the conductors 12 and the groundwall insulation 15, such as disclosed in U.S. Pat. No. 5,723,920 (Markovitz et al.). Alternatively, a conductive paint may be used in place of the conductive tape.

FIGS. 2 and 3 show mica paper tape 16 as a prepreg composed of a mica paper 17 backed by a single woven backing 18 (FIG. 2) or a pair of backings 18a and 18b (FIG. 3), and impregnated with the resin composition of the present invention. In the latter configuration (FIG. 3), one of the backings in 18a or 18b can be a woven fabric, such as fiberglass while the second can be another woven fabric, a non-woven fabric such as a polyester mat, or a polyester or polyimide film. In each case, the resin composition of this invention is used to permeate through the mica paper 17 and to bond each 18, 18a and 18b to the mica paper 17, thereby forming a prepreg tape 16. As such, the resin composition affects the properties of the mica paper tape 16 both while in the prepreg state, and after press-cure and post-cure steps are performed by which the mechanical and electrical properties of the mica paper tape 16 and the groundwall insulation 15 are acquired.

The above described stator bar 10 is merely intended to represent generally conventional conductors over which it is desirable to provide electrical insulation layers formed by a resin-impregnated sheet material. Therefore, it will be understood that the present invention is not limited to the configuration shown in the Figures, and is equally applicable to various other electrical components and assemblies that benefit from the presence of electrical insulation layers. For example, the resin composition of this invention may be employed for various applications other than those involving a prepreg. Accordingly, those skilled in the art will recognize that numerous applications for the resin compositions of this invention are possible, all of which are within the scope of this invention.

It has been found, surprisingly, according to the present invention, that by use of the resin compositions of the invention, the various requirements needed for manufacturing high performance press-cured insulation can be achieved without compromising other properties. Thus, it has been found that by using a combination of a solid or semi-solid epoxy resin having an epoxide functionality of at least 2.5, a cycloaliphatic epoxy resin, a phenol-formaldehyde novolac made with an acidic catalyst, usually oxalic acid, and aluminum acetylacetonate catalyst, the requirements of a press-cure tape can be achieved.

The term “solid” as used herein means a material having a softening temperature or a melt temperature that is above room temperature or 40° C. and higher. The term “semi-solid” as used herein means a material having a softening temperature or a melt temperature that is in the range of 20-39° C.

Heat stable resins for resin-rich mica tapes have low reactivity at ambient temperatures for good shelf life stability combined with high reactivity above 140° C. for application in press-cured tapes. The dissipation factors at room temperature to at least 200° C. are less than 3.0%.

The solid or semi-solid epoxy resin with an epoxide functionality of at least 2.5 constitutes the primary epoxy component for obtaining the desirable adhesive properties for a prepreg impregnated with the resin composition, and for achieving the desirable electrical properties of the resin composition. It has been surprisingly discovered that using only a solid or semi-solid epoxy with an epoxide functionality of at least 2.5, such as epoxy novolacs, as the epoxy component did not result in the high reactivity requirements of a press-cured tape. Other epoxy blends such as those used in U.S. Pat. No. 5,618,891 were also unsuccessful.

It has been unexpectedly found by the present inventors that favorable results are obtained if at least 10% by weight, preferably at least 25%, of the solid or semi-solid epoxy resin is replaced with a cycloaliphatic epoxy resin, such as 3,4-epoxycyclohexylmethy-3,4-epoxycyclohexane carboxylate. A phenol-formaldehyde novolac, from 2.5 to 15.0% by weight is typically used as the accelerator and 0.1 to 1.5% by weight of aluminum acetylacetonate is generally employed as the catalyst.

The solid or semi-solid epoxy resin having an epoxide functionality of at least 2.5 serves as the primary epoxy component for obtaining the desired adhesive properties and the desired pliability of the mica paper tape 16 in its prepreg state. Preferred solid or semi-solid epoxy resin for the resin compositions include epoxy novolacs such DEN 439 and DEN 438, available from Dow Chemical Co., though other epoxy resins having an epoxide functionality of at least 2.5 may be used. The DEN 439 and DEN 438 resins are particularly preferred. DEN 439 is characterized by an epoxide functionality of 3.8, an epoxide equivalent weight of 191 to 210, and a Mettler softening point of about 48° C. to about 58° C. DEN 438 is characterized as having an epoxide functionality of 3.6, an epoxide equivalent weight of 176 to 181, and a viscosity of about 20,000 to 50,000 cps at about 52° C. Another epoxy novolac resin that can be used is DEN 485, also manufactured by Dow Chemical Co. DEN 485 has an epoxide functionality of 5.5, an epoxide equivalent weight of 165 to 195, and a softening point of about 66° C. to about 80° C.

Other solid or semi-solid epoxy resins with an epoxide functionality of at least 2.5 include epoxy cresol novolacs made by Vantico Inc. (formerly Performance Polymers Division of Ciba Specialty Chemicals), such as ECN 1235 with an epoxide functionality of 2.7, an epoxide equivalent weight of 200 to 227, and a melting point of about 34° C. to about 42° C.; ECN 1273 with an epoxide functionality of 4.8, an epoxide equivalent weight of 217 to 233, and a melting point of about 68° C. to about 78° C.; ECN 1280 with an epoxide functionality of 5.0, an epoxide equivalent weight of 213 to 233, and a melting point of about 78° C. to about 85° C.; and ECN 1299 with an epoxide functionality of 5.4, an epoxide equivalent weight of 217 to 244, and a melting point of about 85° C. to about 100° C.

Suitable solid or semi-solid epoxy resins with an epoxide functionality of at least 2.5 also include tetra functional phenol base epoxy resin such as MT0163, available from Vantico Inc. having an epoxide functionality of 4, an epoxide equivalent weight of 179 to 200, and a melting point of 55° C. to about 95° C., and Epon 1031, a polyglycidyl ether of tetraphenylene ethane available from Shell Chemical Co. and having an epoxide functionality of 3.5, and an epoxide equivalent weight of 200 to 240, which is a solid resin having a kinematic viscosity of about Z2 to about Z7 at about 25° C. as an 80 percent weight solution in methyl ethyl ketone.

Other suitable solid epoxy resins with an epoxide functionality of at least 2.5 include modified epoxy novolacs (bisphenol A novolacs) such as EPI-REZ SU™ resins made by Shell Chemical Co., such as EPI-REZ SU-2.5 with an epoxide functionality of 2.5, an epoxide equivalent weight of 180 to 200, and melt viscosity of about 2500 to about 4000 centistokes at about 52° C.; EPI-REZ SU-3.0 with an epoxide functionality of 3.0, an epoxide equivalent weight of 187 to 211, and a melt viscosity of about 20,000 to about 50,000 centistokes at about 52° C.; and EPI-REZ SU-8 with an epoxide functionality of 8.0, an epoxide equivalent weight of 195 to 230, and a melting point of about 77° C. to about 82° C.

The solid or semi-solid epoxy resin having an epoxide functionality of at least 2.5 comprises from more than 50 weight percent to 90 weight percent of the total epoxy resin content. The cycloliphatic epoxy resin content comprises from about 10 to less than 50 weight percent of the total epoxy resin content. Cycloaliphatic epoxy resins include ERL-4221 or ERL-4221E made by Dow Chemical Co. (formerly Union Carbide) or CY-179 made by Vantico Inc.(formerly Performance Polymers Division of Ciba Specialty Chemicals). ERL-4221, ERL-4221E and CY-179 is 3,4-epoxycyclohexylmethyl-3,4-epoxy-cyclohexane carboxylate having an epoxy equivalent weight of 131 to 143 and a viscosity of 350 to 450 cps at 25° C. Other cycloaliphatic epoxy resins that may be used include: Dow's ERL-4206, vinyl cyclohexene dioxide, having an epoxy equivalent weight of 70 to 74 and a viscosity of less than 15 cps at 25° C.; Dow's ERL-4234, 2-(3,4epoxycyclohexyl-5,5-spiro-3,4-epoxy) cyclohexane-meta-dioxane, having an epoxy equivalent weight of 133 to 154 and a viscosity of 7,000 to 17,000 cps at 38° C.; and Dow's ERL-4299, bis(3,4-epoxycyclohexyl) adipate, having an epoxy equivalent weight of 190 to 210 and a viscosity of 550 to 750 cps at 25° C. These cycloaliphatic epoxy resins may be manufactured by other suppliers.

The phenol-formaldehyde novolac is used as an accelerator for the cure. It is present from 2.5 to 15.0 parts-by-weight while the solid or semi-solid epoxy resin plus the cycloaliphatic epoxy resin comprise 100.0 parts-by-weight. Examples of novolacs are phenolic resins made by Georgia-Pacific Resins, Inc. such as BRWE 5555, having a hydroxyl equivalent weight of 106 and a melt viscosity at 150° C. of 800 to 2,500 cps; BRWE 5833, having a hydroxyl equivalent weight of 106 and a melt viscosity at 150° C. of 2,500 to 7,000 cps; and BRWE 5853, having a hydroxyl equivalent weight of 106 and a melt viscosity at 150° C. of 4,500 to 7,000 cps. While a phenol-formaldehyde novolac is the preferred accelerator, a portion of the phenol-formaldehyde novolac may be replaced with other novolacs or with phenolic compounds. Examples of other novolacs are bisphenol A-formaldehyde novolacs or an alkylated phenol-formaldehyde novolac. Examples of phenolic compounds are bisphenol A, para-nitrophenol, resorcinol, catechol and hydroquinone.

Aluminum acetylacetonate is used as the catalyst for the cure. It is present from 0.1 to 1.5 parts-by-weight while the solid or semi-solid epoxy resin plus the cycloaliphatic epoxy resin comprise 100.0 parts-by-weight and the novolac accelerator comprises 2.5 to 15.0 parts-by-weight.

### EXAMPLES

The invention is now further described with reference to the following examples, in which percentages are by weight.

Examples 1 and 2 are for comparisons to the prior art. Example 1 uses a boron trichloride-amine catalyst while Example 2 uses a boron trifluoride-amine catalyst. Note the undesirable high dissipation factor values obtained at elevated temperatures. Examples 3 to 6 of the invention demonstrate varying the ratio of the solid or semi-solid epoxy resin to the cycloliphatic epoxy resin while keeping the phenolic accelerator content and that of the aluminum acetylacetonate catalyst the same. In Examples 7 to 10, the only variable is the phenol novolac accelerator content. Note the combination of high reactivity at press-cure temperatures combined with long shelf life stability at room temperature and the excellent electrical properties at room temperature to at least 200° C.

### Example 1

(Prior Art)

Dissipation factor (DF) at 60 Hz. and 10 VPM (volts-per-mil) of an epoxy resin for a press-cured tape that uses a boron trichloride-amine catalyst had a DF of 0.46% at 25° C. that rose to 15.33% when tested at 160° C.

### Example 2

(Prior Art)

The % dissipation factor at 60 Hz. and 10 VPM of an epoxy resin for a press-cure tape that uses a boron trifluoride-amine catalyst had DF values of 0.80% at 25° C. that rose to 6.14% and 9.42% at 155 and 170° C., respectively.

### Example 3

A resin was made by dissolving 12.5 parts-by-weight of phenol-formaldehyde novolac BRWE 5833 in 90.0 parts-by-weight of epoxy novolac DEN 439 at about 120° C. It was blended with a solution made from 10.0 parts-by-weight of ERL-4221E and 0.25 parts-by-weight of aluminum acetylacetonate. The gel time of the resin was 89 seconds at 160° C. but the resin had a shelf life of more than 6 months at room temperature. The % dissipation factors at 60 Hz. and 10 VPM after a 12 hours at 160° C. cure were 0.36, 1.16 and 1.54 at 25° C., 155° C. and 200° C., respectively.

### Example 4

A resin was made by dissolving 12.5 parts-by-weight of phenol-formaldehyde novolac BRWE 5833 in 80.0 parts-by-weight of epoxy novolac DEN 439 at about 120° C. It was blended with a solution made from 20.0 parts-by-weight of ERL-4221E and 0.25 parts-by-weight of aluminum acetylacetonate. The gel time of the resin was 76 seconds at 160° C. but the resin had a shelf life of more than 6 months at room temperature. The % dissipation factors at 60 Hz. and 10 VPM after a 12 hours at 160° C. cure were 0.38, 1.02 and 1.08 at 25° C., 155° C., and 200° C., respectively.

### Example 5

A resin was made by dissolving 12.5 parts-by-weight of phenol-formaldehyde novolac BRWE 5833 in 70.0 parts-by-weight of epoxy novolac DEN 439 at about 120° C. It was blended with a solution made from 30.0 parts-by-weight of ERL-4221E and 0.25 parts-by-weight of aluminum acetylacetonate. The gel time of the resin was 75 seconds at 160° C. but the resin had a shelf life of more than 6 months at room temperature. The % dissipation factors at 60 Hz. and 10 VPM after a 12 hours at 160° C. cure were 0.40, 1.13 and 1.10 at 25° C., 155° C., and 200° C., respectively.

### Example 6

A resin was made by dissolving 12.5 parts-by-weight of phenol-formaldehyde novolac BRWE 5833 in 60.0 parts-by-weight of epoxy novolac DEN 439 at about 120° C. It was blended with a solution made from 40.0 parts-by-weight of ERL-4221E and 0.25 parts-by-weight of aluminum acetylacetonate. The gel time of the resin was 70 seconds at 160° C. but the resin had a shelf life of more than 6 months at room temperature. The % dissipation factors at 60 Hz. and 10 VPM after a 12 hours at 160° C. cure were 0.39, 1.01 and 1.20 at 25° C., 155° C., and 200° C., respectively.

### Example 7

A resin was made by dissolving 8.0 parts-by-weight of phenol-formaldehyde novolac BRWE 5833 in 70.0 parts-by-weight of epoxy novolac DEN 439 at about 120° C. It was blended with a solution made from 30.0 parts-by-weight of ERL-4221E and 0.25 parts-by-weight of aluminum acetylacetonate. The gel time of the resin at 160° C. was 60-90 seconds and had a shelf life of more than 6 months at room temperature. The % dissipation factors at 60 Hz. and 10 VPM after a 12 hours at 160° C. cure were 0.47, 1.41, 1.73 and 1.88 at 25° C., 155° C., 180° C. and 200° C., respectively.

### Example 8

A resin was made by dissolving 10.0 parts-by-weight of phenol-formaldehyde novolac BRWE 5833 in 70.0 parts-by-weight of epoxy novolac DEN 439 at about 120° C. It was blended with a solution made from 30.0 parts-by-weight of ERL-4221E and 0.25 parts-by-weight of aluminum acetylacetonate. The gel time of the resin at 160° C. was 60-90 seconds and had a shelf life of more than 6 months at room temperature. The % dissipation factors at 60 Hz. and 10 VPM after a 12 hours at 160° C. cure were 0.39, 1.21, 1.66 and 1.78 at 25° C., 155° C., 180° C. and 200° C., respectively.

### Example 9

A resin was made by dissolving 12.0 parts-by-weight of phenol-formaldehyde novolac BRWE 5833 in 70.0 parts-by-weight of epoxy novolac DEN 439 at about 120° C. It was blended with a solution made from 30.0 parts-by-weight of ERL-4221E and 0.25 parts-by-weight of aluminum acetylacetonate. The gel time of the resin at 160° C. was 60-90 seconds and had a shelf life of more than 6 months at room temperature. The % dissipation factors at 60 Hz. and 10 VPM after a 12 hours at 160° C. cure were 0.39, 1.09, 1.49 and 1.78 at 25° C., 155° C., 180° C. and 200° C., respectively.

### Example 10

A resin was made by dissolving 14.0 parts-by-weight of phenol-formaldehyde novolac BRWE 5833 in 70.0 parts-by-weight of epoxy novolac DEN 439 at about 120° C. It was blended with a solution made from 30.0 parts-by-weight of ERL-4221E and 0.25 parts-by-weight of aluminum acetylacetonate. The gel time of the resin at 160° C. was 60-90 seconds and had a shelf life of more than 6 months at room temperature. The % dissipation factors at 60 Hz. and 10 VPM after a 12 hours at 160° C. cure were 0.40, 1.02, 1.34 and 1.79 at 25° C., 155° C., 180° C. and 200° C., respectively.

While the examples of this invention used two epoxy resins, the epoxy novolac DEN 439 and the cycloaliphatic epoxy resin ERL-4221E, other combinations of epoxy resins can be used. The solid or semi-solid epoxy resin with an epoxide functionality of at least 2.5 can be blended with other solid or semi-solid epoxy resins having an epoxide functionality of at least 2.0 so that the blend comprises from more than 50 weight percent to 90 weight percent of the epoxy resins used. In place of ERL 4221-E, other cycloaliphatic epoxy resins or blends of cycloaliphatic epoxy resins can be used. The cycloaliphatic epoxy resin or blend of cycloaliphatic epoxy resins comprises from about 10 to less than 50 weight percent of the total epoxy resin content. While the examples used only the phenol-formaldehyde novolac BRWE 5833, other phenol-formaldehyde novolacs or novolacs made from other phenols or blends of novolacs or blends of novolacs with phenolic compounds can be used to obtain 2.5 to 15.0 parts-by-weight while the combination of the two or more epoxy resins comprise 100.0 parts-by-weight.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A resin composition comprising an epoxy resin having an epoxide functionality of at least 2.5, a cycloaliphatic epoxy resin, a phenolformaldehyde novolac and aluminum acetylacetonate.

2. A resin according to claim 1 wherein said epoxy resin having an epoxide functionality of at least 2.5 is an epoxy novolac.

3. A resin according to claim 2 wherein said epoxy novolac is selected from the group consisting of DEN 438, DEN 439 and DEN 485.

4. A resin according to claim 2 wherein said epoxy novolac is selected from the group consisting of ECN 1235, ECN 1273, ECN 1280 and ECN 1299.

5. A resin according to claim 2 wherein said epoxy novolac is selected from the group consisting of EPI-REZ SU-2.5, EPI-REZ SU-3.0 and EPI-REZ SU-8.0.

6. A resin according to claim 2 wherein said epoxy resin is selected from the group consisting of MT0163 and Epon 1031.

7. A resin according to claim 1 wherein said epoxide functionality of one of the epoxy resins is about 2.7-8.0.

8. A resin according to claim 1 wherein said epoxy resin having an epoxide functionality of at least 2.5 comprises from 50 to 90 wt % of the total epoxy resin content of the composition.

9. A resin according to claim 1 wherein said cycloaliphatic epoxy resin is present in an amount of at least 10% by weight.

10. A resin according to claim 1 wherein said cycloaliphatic epoxy resin is present in an amount of 10% to 50% by weight.

11. A resin according to claim 1, wherein said cycloaliphatic epoxy resin is present in an amount of at least 25%.

12. A resin according to claim 1 wherein said cycloaliphatic epoxy resin is selected from the group consisting of ERL-4221, ERL-4221E, ERL4206, ERL-4234, ERL-4299 and CY-179

13. A resin according to claim 1 wherein said cycloaliphatic epoxy resin is 3,4epoxycyclohexylmethyl-3,4-epoxy-cyclohexane carboxylate.

14. A resin according to claim 1 wherein said phenol-formaldehyde novolac is present in an amount of from 2.5 to 15.0 parts by weight, and the epoxy resin and cycloaliphatic epoxy resin comprise 100.0 parts by weight.

15. A resin according to claim 1 wherein said phenol-formaldehyde novolac is selected from the group consisting of BRWE 5555, BRWE 5833 and BRWE 5853.

16. A resin according to claim 1 wherein 20-80% by weight of said phenol-formaldehyde novolac is replaced by another novolac or by a phenolic compound.

17. A resin according to claim 16 wherein said other novolac is selected from the group consisting of bisphenol A-formaldehyde novolacs and alkylated phenol-formaldehyde novolacs.

18. A resin according to claim 16, wherein said phenolic compound is selected from the group consisting of bisphenol A, para-nitrophenol, resorcinol, catechol and hydroquinone.

19. A resin according to claim 1 wherein said phenol-formaldehyde novolac is made with an acidic catalyst.

20. A resin according to claim 3 wherein said acidic catalyst is oxalic acid.

21. A resin according to claim 1 wherein said aluminum acetylacetonate catalyst is present in an amount of 0.1 to 1.5 parts by weight, the epoxy resin and cycloaliphatic epoxy resin comprise 100.0 parts by weight and the novolac accelerator comprises 2.5 to 15.0 parts by weight.
